(19) United States
(12) Patent Application Publication
(10) Pub. No.: US 2004/0233193 A1
(43) Pub. Date: Nov. 25, 2004

(54) Method for visualising a spatially resolved data set using an illumination model

(75) Inventor: Felix Margadant, Maienfeld (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Markets and Technology AG, Winterthur (CH)

(21) Appl. No.: 10/814,827

(22) Filed: Mar. 30, 2004

(30) Foreign Application Priority Data
Apr. 30, 2003 (EP) 03405303.3

(51) Int. Cl. G06T 15/00

(52) U.S. Cl. 345/419

(57) ABSTRACT

In accordance with the invention, a method for visualising a spatially resolved data set (D) using an illumination model (BM) is proposed, with a datum (D(α, β, γ)) of the data set (D) being associated in each case with a volume element (V) whose position is described by coordinates (α, β, γ) in a measurement coordinate system (Kₘ). The data (D(α, β, γ)) are loaded as at least one texture (Tαᵢ, Tβⱼ, Tγₖ) into graphics hardware (4) in order to generate a pictorial representation (5) in a projection space. The illumination model (BM) is evaluated in the measurement coordinate system (K_{M}).

The invention relates to a method for visualising a spatially resolved data set using an illumination model as well as to the use of this method for the generation of three-dimensional representations of a body in accordance with the preamble of the independent claim of the respective category.

For the representation of data sets of three or more dimensions, two-dimensional projections of these volumes or hypervolumes are often used which can then be graphically output and interpreted by the user. For the quite frequent case that the volume is available in Cartesian or isotropic form, and the volumes are thus arranged in an orthogonal raster which has the same resolution in all three spatial directions, many graphics accelerators of modern data processing unit have hardware which can efficiently be used directly to carry out the volume visualisation. Such an equipping with graphics accelerators in the form of graphics cards has become an established standard in the meantime even with commercial personal computers.

The visualisation of spatially resolved data sets by three-dimensional pictorial representations, for example in one plane, is becoming increasingly important in many technical fields. This relates both to animations, for example for computer games or in advertising, and to the industrial sector and in particular to modern medical diagnosis and therapy. A number of image-producing examination methods are known here such as, among others, computer tomography, nuclear spin tomography or methods of ultrasonic technology, which should provide representations of specific regions of the human body, of organs, of the inside of blood vessels or of the heart, of the human skull, etc. It is here increasingly a question of imaging both substantially static images and moving processes in real time where possible. This is of central importance, for example in the observation of the movement of the heart by means of a catheter, or if a corresponding measuring probe, e.g. an ultrasonic probe, has to stand in for the eye of the physician in an operation. Related image-producing methods are naturally also well known from industrial engineering, for example for the non-destructive inspection of safety-relevant components such as wheelsets and axle sets in rail vehicles, pressure containers, pipes and thin lines, e.g. in power plant technology and in many more other areas.

Moreover, the visualisation of spatially resolved data sets by three-dimensional pictorial representations in particular of radar data, sonar data (localisation and navigation) of seismic data sets, of weather data or, for example, the visualisation as part of finite element analyses is becoming more and more important. There are, however, also numerous applications for computer simulations in the most varied areas, among others in the area of radar engineering, ultrasound engineering and sonar engineering.

Importance is also increasingly being put on a more and more realistic representation of the dates sets detected in a technical measurement and then projected. This means that the trend is towards a higher and higher spatial resolution of the object to be observed, with it being a question of projecting the data set which is detected by a measuring apparatus and is as a rule three-dimensional in a-perspectively correct manner and of inscribing light reflections into the projected volume in a realistic manner in order to assist human visual acuity in orientation in spatial depth in a three-dimensional graphical data set. The inscribing in of illumination effects into the projection is of particular importance in particular with stereoscopic projections, that is when a three-dimensional image should be communicated to the human visual acuity by a suitable projection device by superimposition of two projections slightly rotated in perspective.

For this purpose, a specific illumination model is used as a base which is described by so-called illumination functions which approximate the interaction of light radiated in (virtually) with the objects in the volume, including attenuation, reflection and scattering. It is obvious that enormous computer power is necessary for this which cannot even easily be provided by the computer systems available on the market today.

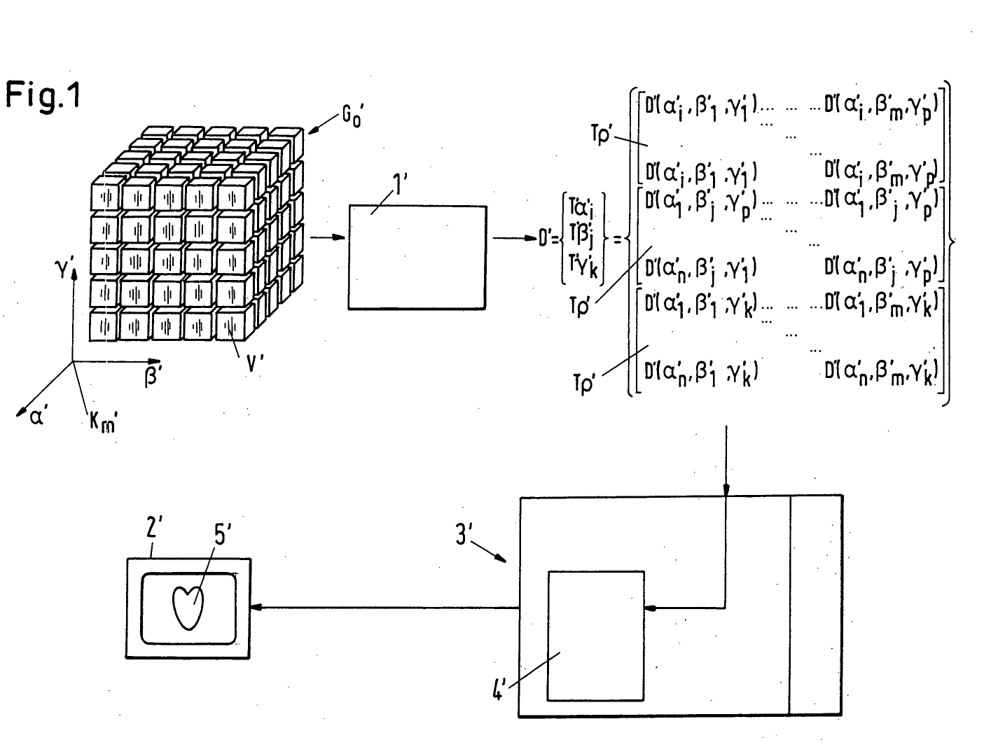

The principle known from the prior art of the visualisation of multi-dimensional graphical data sets using commercial graphics hardware while taking a specific illumination model into account should be briefly outlined in the following with reference to FIGS. 1 to 3. To distinguish the prior art from the method in accordance with the invention, the reference numerals are provided with a dash in FIGS. to 3. All the principles known from the prior art for the visualisation of data sets D′, which include data D′ (α′, β′, γ′) (measured in a measurement coordination system K′ₘ with coordinate axes α′, β′, γ′) have the fact in common that the illumination functions which define the illumination model are evaluated in the projection space P′, since the visual vector S′ of the observer or of the illumination vector is naturally defined there. Within the context of this application, the process of calculating the illumination functions is designated as “shading” on the basis of the nomenclature of the relevant literature. The process designated as “rendering” in the context of this invention must be distinguished from this. Rendering should be understood in the following as the linearisation after the cutting in an original volume or in a measured data set and the subsequent transformation of the intersections into the geometry of a projection space.

In a simple case, as shown schematically in FIG. 1 for a known example from the prior art, the data set D′ which is to be visualised and which was generated, for example, by an appropriate rule or by a measuring apparatus 1′ by a nuclear spin tomogram 1′ by measurement in an original volume Gₒ′, is available in Cartesian or isotropic form. The original volume Gₒ′ has the shape of a right parallelepiped and the volume elements V′ are arranged in an orthogonal raster which has the same resolution in all three spatial axes α′, β′, γ′ of the measurement coordinate system K′ₘ. The data set D′ is loaded into a data processing unit 3′ for the projection of such a data set D′, for example, onto a viewing monitor 2′. Said data processing unit has commercial graphics accelerators, which include graphics hardware 4′, which can be used efficiently to carry out the volume visualisation.

The concept of texture is frequently used for this, with the texture being defined by a data set from which two-dimensional polygonal surfaces can be copied, i.e. read, which corresponds to the aforesaid graphical cutting operation.

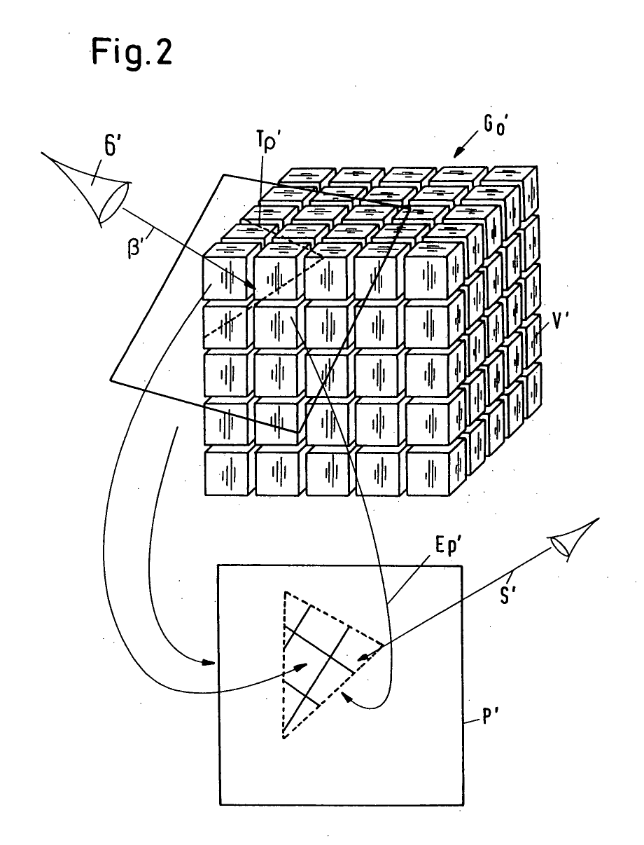

For this purpose, as shown schematically in FIG. 2, any desired polygon is imaged onto another polygon Eₚ′ in the projection space P′ for the imaging of a digital image 5′ from the original volume Gₒ′, i.e. from a digital data set D′, with the polygon Tρ′ of the original volume Gₒ′ not having to be geometrically similar to the polygon Eₚ′ in the projection space P′. If, as in the present example, an original volume Gₒ′ is represented up by a three-dimensional data set D′ which is built up of one or more 2D or 3D textures Tρ′, such a three-dimensional data set D′ is frequently also termed a 3D texture.

It is understood that, in a particularly simple case, the texture Tρ′ can be identical to the polygon from the cutting operation.

The original volume Gₒ′, that is the data set D′, is divided, for example perpendicular to a direction of observation B′ of a (virtual) observer 6′, into a specific number of textures Tρ′ whose corners are then rotated into the observation position, rotated, corrected perspectively and presented. This representation of the original volume Gₒ′ as a two-dimensional projection is achieved by repeated “cutting” of the original volume Gₒ′, i.e. of the three-dimensional data set D′ perpendicular to the direction of observation 6′. The cutting consists of the values being interpolated from the data set D′ and projected into a projection plane which, in the present case, is identical to the projection space P′.

The set of the slices which are two-dimensional images here must then be assembled to one single image 5′ by an integration rule. The integration rule can be a simple point-by-point adding or can take place by a specific rule which is often also termed an illumination function as part of a so-called illumination model. The illumination functions or the illumination models therefore approximately take into account the interaction of light radiated in (really or virtually), including attenuation, reflection and scattering, with the objects of the original volume Gₒ′, that is the three-dimensional data set D′, by the process of shading.

If a stereoscopic projection should be achieved, the previously described method must additionally be carried out with respect to at least one second visual vector whose direction is slightly different from the visual vector S′ and must be supplied to a suitable stereoscopic projection device. I.e., a view must be calculated for each eye in accordance with its position.

The literature of volume visualisation knows a number of approaches to ascribe optical features to a data set D′ to be visualised. The best known class of such methods considers the intensity as a form of the optical density so that fluctuations in density cause light scattering and reflection and the density itself becomes light absorbing. In the literature, algorithms which are based on this hypothesis are generally termed gradient renderers.

The illumination functions are naturally evaluated in the projection space P′, since the visual vector S′ and the illumination vector are defined there. This means that the original volume Gₒ′ (that is the data set D′) is initially cut into planes, i.e. sliced into textures Tρ′, and imaged in the projection space P′, a process which is also termed texture remapping in the literature. Subsequently, the illumination functions are evaluated in projection space P′, that is are applied to the projected (that is rotated and corrected) textures Tρ′ in the projection space P′.

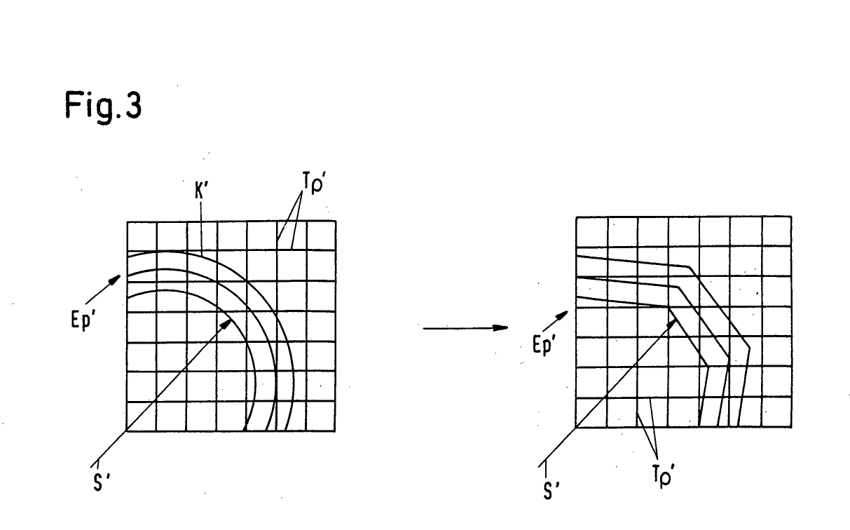

This method known from the prior art is disadvantageous, on the one hand, because the visual vector S′ or the illumination vector do not have a constant amount either on the planar textures Tρ′ of the original volume Gₒ′ or on the projected planes Eₚ′ in the projection space P′; the amount of the visual vector is rather, as shown schematically in the left hand image of FIG. 3, constant at spherical shells K′. The visual vector S′ and the illumination vector thus generally change over a slice, i.e. over a planar texture Tρ′ or over a plane Eₚ′, in the projection space P′.

The planes which are marked by visual vectors S′ with a constant amount therefore form concentric spherical shells K′ in the original volume Gₒ′. Because amount-wise changes of the visual vector S′ thus do not depend linearly on the texture coordinates of the textures Tρ′ or of the projected planes Eₚ′, these can also not be encoded directly on the graphics hardware 4′. In these methods known from the prior art, the projection plane Eₚ′ must therefore be sliced into smaller areas in the projection space P′ as shown schematically in the right hand image of FIG. 3, with linear interpolation being carried out between the corner points of the part areas.

In addition to various disadvantages such as an increase in the required calculation time, a particularly serious disadvantage lies in the fact that linearisation errors necessarily occur in the projection space P′ due to the previously described interpolation.

Whereas the previously mentioned linearisation errors still move within a justifiable limit with the imaging of a substantially Cartesian and isotropic original volume Gₒ′, that is of a Cartesian data set D′, the linearisation errors in non-Cartesian data sets D′ are unjustifiably high so that either no usable image is produced in the projection space P′ or the calculation effort increases so drastically that real time imaging such as is often absolutely necessary, for example in medical engineering, is no longer possible with the projection methods known from the prior art and with the currently available hardware. It is understood that the calculation effort increases drastically again by an additional evaluation of the illumination functions in the projection space P′ and is increased even further with a stereoscopic projection.

The data sets D′, which were acquired in the original volume Gₒ′, are not, however, present in Cartesian, i.e. in orthogonal, coordinates in many applications important for practice. The reason for this is primarily the type of data acquisition. Typical examples are (X-ray) computer tomography or special ultrasonic techniques in which the data D′ to be projected are present, for example, in cylindrical coordinates. When using very modern scanning systems, the relatively long time which is required for the preparation of a three-dimensional image in the projection space P′ with the known methods of the prior art is caused less by the data acquisition as such, that is by the preparation of the data set D′ per se, but rather by the process of the visualisation of the data set D′. Ultrasonic probes are thus already known which scan very quickly and with which an original volume Gₒ′ of interest is scanned in a plurality of planes simultaneously and in circular form. Such ultrasonic probes include, for example, a plurality of ultrasonic converters which can be swivelled or rotated about an axis, or are arranged in linear form or generally in an array and of which some or all are operated in parallel so that a simultaneous cylindrically symmetrical scanning is made possible simultaneously in a plurality of planes. Such fast scanning ultrasonic probes are very frequently not able to measure the volume in a Cartesian manner simply for reasons of efficiency.

The data sets D′ acquired in this way are thus present in cylindrical symmetry and cannot be encoded directly on conventionally available graphics hardware. If a fast visualisation of the data sets D′ is necessary, for example to achieve a real time representation at video frequencies with typical response times of less than 1/25 seconds, complicated and time-intensive calculating operations for the preparation of the measured data sets D′ can basically not be allowed for the processing in the graphics hardware 4′. In particular a complex coordinate transformation into a Cartesian coordinate system is thus eliminated.

EP 1 059 612 recites a method for the visualisation of a spatially resolved data set D′ to satisfy this problem which also allows non-Cartesian data sets D′ to be processed enormously fast on generally available graphics hardware 4′, such as is used in commercial personal computers, in a particularly efficient manner by avoiding complex part steps and so allows three-dimensional representations, even of moving objects, to be projected and represented in real time, i.e. at typical video frequencies. The aforesaid method is described in detail in EP 1 059 612 A1, whose content is herewith included in this application, and therefore no longer needs to be described in detail.

The method proposed in EP 1 059 612 A1 admittedly allows multi-dimensional data sets D′, which are present in any desired curvilinear coordinates, e.g. in cylindrical symmetry or spherical symmetry, to be encoded directly and enormously fast on conventional graphics hardware in a particularly elegant and efficient manner without any great calculation effort. However, the problem of the fast and efficient evaluation of the illumination function remains unsolved.

Starting from this prior art, it is therefore an object of the invention to provide a method for the visualisation of a spatially resolved data set that allows the illumination function to be evaluated in a particularly efficient manner, with the required calculation time being enormously reduced in comparison with methods of the prior art.

The subject matters of the invention which satisfy this object are characterised by the features of the independent claim of the respective category.

The dependent claims relate to particularly advantageous embodiments of the invention.

In accordance with the invention, a method is thus proposed for visualising a spatially resolved data set using an illumination model, with one datum of the data set being respectively associated with one volume element whose position is described by coordinates in a measurement coordinate system. The data are loaded into a graphics hardware as at least one texture in order to produce a pictorial representation in a projection space. The illumination model is evaluated in the measurement coordinate system.

It is thus material to the invention for an illumination model used as the basis for the visualisation of the data set or for the illumination functions defining the illumination model to be evaluated in the measurement coordinate system. This means that the process of shading takes place completely in the original volume and is completely separated from the process of rendering as it was initially described.

The data of the data set which were generated in a measurement, for example in a measurement on the heart by means of an ultrasonic probe, are preferably processed without transformation from the measurement coordinate system into another coordinate system, in particular without transformation into a Cartesian and/or isotropic coordinate system. This means that when the method in accordance with the invention is used in which the illumination functions are evaluated in the measurement coordinate system, the data are prepared by elementary calculation operations such that they can be loaded into the graphics hardware and be processed by this.

The method in accordance with the invention is preferably used in an embodiment in which the measurement coordinate system is a non-Cartesian measurement coordinate system. The measurement coordinate system can specifically be a cylindrical or spherical coordinate system or another non-Cartesian coordinate system. The data can thus, for example, be generated by means of a rotating ultrasonic probe scanning at very high speed. Using such ultrasonic probes, it is possible to scan an original volume of interest, for example the interior of a human heart, simultaneously and in circular form in a plurality of planes. Such ultrasonic probes can include a plurality of ultrasonic converters swivellable or rotatable about an axis and arranged in linear form or generally in an array such that a simultaneous cylindrically symmetrical scanning is made possible in a plurality of planes. The measurement coordinate system in which the data of the data set are present thus likewise has cylindrical symmetry.

It is understood that the method in accordance with the invention can also advantageously be used in a special embodiment on data of a Cartesian data set. The method in accordance with the invention is thus by no means restricted to non-Cartesian measurement coordinate systems.

In an embodiment of the method in accordance with the invention which is important for practice, linear interpolation is carried out between the data of the data set in the measurement coordinate system. The data can thereby be loaded into the graphics hardware and be processed by this without carrying out coordinate transformation into a Cartesian system.

Not least due to the fact that the data of the measurement data set which can be present in a curvilinear non-Cartesian measurement coordinate system, for example in cylindrical coordinates or in spherical coordinates, can be loaded into the graphics hardware and be processed by this without a previous coordinate transformation in an embodiment of the method in accordance with the invention which is very important for practice, the data of the data set can also be evaluated close to a singularity. Such singularities can be found, for example, in cylindrical coordinates which can be described by a coordinate which corresponds to a radius, by an angular coordinate and by a further spatial coordinate at a value of the radius of zero. That is, the statement “a singularity is present at radius zero” is to be understood such that the data cannot be evaluated by a coordinate transformation in a measurement coordinate system with cylindrical symmetry in the proximity of or exactly at points having a value of the radius coordinate of zero. Since, however, no coordinate transformation takes place in the embodiment described above, data of the data set close to a singularity can also be evaluated by application of this embodiment of the method in accordance with the invention. The method in accordance with the invention can naturally generally also be used when the data of the data set are subjected to a coordinate transformation, in particular for the further processing in the graphics hardware.

In a further variant of the method in accordance with the invention, the data of the data set can in particular represent a volume-resolved scan of a body, for example of part of a human body such that the pictorial representation is a three-dimensional volume representation, in particular also, among other things, a semi-transparent representation of the body. Such representations are, among other things, of advantage when the observer has to orient himself in the volume of the body represented and/or when the body or parts of the body represented is/are subject to specific motions. The method can thus be used particularly advantageously, among other things, for the observation of a beating heart or in an operation on the beating heart, for example using an ultrasonic measuring device. Since it is possible to generate enormously fast three-dimensional representations with the help of customary graphics hardware by using the method in accordance with the invention, three-dimensional images of very high resolution are possible in real time, also with video frequencies with response times of typically 1/25 seconds.

It is naturally also possible by using the method in accordance with the invention or by using one or more, i.e. by using a suitable combination, of the previously described embodiments, to generate the pictorial representation as a stereoscopic projection. The inscription of illumination effects into the projection is of particular importance in particular for such stereoscopic projections, when—that is—the human visual acuity should be supplied with a three-dimensional image by superimposition of two projections slightly displaced in perspective by a suitable projection device. Since the different embodiments of the method in accordance with the invention allow an enormously fast processing of the pictorial data, i.e. in particular allow an enormously fast and efficient processing of the illumination functions in the measurement coordinate system, even stereoscopic projections, possibly using suitable projection apparatuses such as suitable 3D spectacles, even of movements, are possible in real time and at extremely high resolution.

The method is this in particular suitable in its various embodiments for use for medical purposes, for the fast generation of three-dimensional representations of a body, in particular of a human body or parts thereof, using data gained by a technical measurement.

It is understood that any suitable combination of the previously represented embodiments can also be used advantageously and that the method is furthermore exceptionally suitable not only for medical purposes, but very generally also in industrial engineering, e.g. for the investigation of regions of a plant with difficult access. The data of the data set to be visualised in particular do not necessarily have to be generated by a technical measurement device such as an ultrasonic probe, but can also be made available, for example, by a mathematical rule, by a simulation or in a different manner.

Before the invention is described in more detail with reference to the drawing, for the better understanding of the present application text, the mathematical principles material to the invention for the visualisation of a spatially resolved data set, in particular of a non-Cartesian data set, should be explained.

Since, in the imaging process, planes of the original volume are not imaged in planes, but—due to the perspective—in spherical shells in the projection space, the visual vector and the illumination vector change over a projected section. Because this change does not depend on the coordinates of the texture in a linear manner, but at best approximately, it cannot be encoded on the hardware as a texture operation. The texture is therefore divided into smaller part areas and is interpolated in a linear manner between the corner points of the part areas. The corner points of these part areas are also designated as vertices. Such a dividing into smaller part areas is designated as tessellation in the context of this application. The tessellation takes place in the original volume. The original volume is cut into concentric spherical shells such that the amount of the observation vector at a given texture which corresponds to a cut-out spherical shell remains constant such that the observation vector does not have to be corrected. The resolution losses due to the correction operations which usually occur are thereby minimised. The geometry is therefore linearised in the original volume in that the illumination function is also evaluated in accordance with the invention.

The maximum error which arises due to a tessellation using angular increments of small angles α at an observation radius r is

$$err = r ( 1 - cos ( \frac{α}{2} ) ) \approx r \frac{{α}^{2}}{4} . \qquad ( eq . 1 )$$

An upper limit for the increment in mass units of pixels thus results at an error of

$$err = \leq \frac{1}{2} as α \leq \sqrt{\frac{2}{r}} ,$$

for r=200, that is approximately six degrees. This error can be partly tolerated in Cartesian volumes, but is absolutely unjustifiably large in curvilinear coordinates such as in systems with spherical or cylindrical symmetry.

One solution is the so-called “inner shading” in accordance with the present invention whose mathematical principles will be explained in more detail in the following. In inner shading, the geometry of the original volume is linearised in its non-Cartesian coordinates and the vertices are transformed into the geometry of the projection space. The observation vectors and illumination vectors are evaluated in the original volume and the illumination volumes are reshaped such that they apply in the original volume. The shading thus takes place completely in the original volume, from which the designation “inner shading” is derived.

The steps of shading and rendering are thus completely separated in accordance with the present invention. The original volume is first shaded at least element-wise and is then rendered via texture slices. If the total original volume is first completely shaded and only then rendered, then one also speaks of a “two-stage inner shading” in this specific implementation.

To implement the method, the tessellation and the shape of the illumination functions in the original volume must be given. The three coordinates in the original volume are designated by (α, β, γ) and those of the Cartesian projection space as (x, y, z). The transformation T between the systems is (x, y, z)=T(α, β, γ)−T is i.a. not a linear operator; its inverse T⁻¹ must, however, exist, with the exception of the singularities. The corresponding linear operators are stated as follows:

x=Tₓ(α, β, γ), y=T_{y}(α, β, γ) and z=T_{z}(α, β, γ).

In the case of spherical coordinates, (α, β, γ)=(r, φ, φ) and x=r·cos(φ)cos(φ), y=r·cos(φ)sin(φ) and z=r·sin(φ); one can use (α, β, γ)=(r, φ, φ) for cylindrical coordinates, and obtains x=r·cos(φ), y=r·sin(φ) and z=z.

It is known from the literature that a gradient can be converted into an illumination value in that it is used as an indicator in a data field which is arranged at the side faces of the unit cube. The values of the shading are therefore tabulated with reference to the vectors of the observation and of the illumination and are then stored in a table, termed a cube map. This reduces the problem to showing that the shading can be tabulated in dependence on the gradient in the original volume.

This is trivially the case—in the filling of the cube map, the gradient vector corresponds to the vector from the origin to the position in the cube map to be calculated; this vector n₍₀₎ is present at G₀, it can therefore be transformed point-wise into the projection space by means of T:

$${n}_{( p )} ( {x}_{p} ) := \frac{ⅆ T}{ⅆ {n}_{( o )}} ( {x}_{0} ) . \qquad ( eq . 2 )$$

Its illumination function can then be calculated.

The definition applies xₚ:=T(x₀), where

$$\frac{ⅆ T}{ⅆ n} ( x )$$

is the direction derivation of T in the direction of n at the point x. Since both T and

$$\frac{ⅆ T}{ⅆ n}$$

are i.a. non-linear, the cube map does not only have to be calculated again for each node of the tessellation, but it can also be incorrectly interpolated between the points. This general approach can therefore not be followed for curvilinear coordinates.

It should be shown in the following that the shading values can be gained from the gradients of the original volume by means of the four elementary calculating operations. This is only conceivable as an approximation, which will be recited in the following, due to the generality of the transformation T.

For this purpose, two vertices \vec{x}₀ and \vec{x}ᵢ of the tessellation are observed, between which all functions should be interpolated linearly. The Cartesian gradients \vec{g}ᵢ :=∇(T(V(\vec{x}ᵢ))) for each i can be recalculated into illumination values by hardware. However, only the gradients \vec{g}₀₁ :=∇(V(\vec{x}ᵢ)) are available which, in accordance with the invention, should not be transformed by a rotation.

The normals must therefore be derived by the differential from T: a normal component g in the direction α at the coordinate \vec{x}₀=(α, β, γ) is then expressed in the projection space by

$$g \cdot \frac{\partial T}{\partial α} ( {\vec{x}}_{0} ) .$$

Because the direction vectors are locally defined and can be locally differentiated, they can be transformed linearly and the transition matrix Gₒ→Gₚ (original volume by projection space) of the normal vectors at the point \vec{x}₀ can be recited:

$$N := ( \begin{matrix}\frac{\partial {T}_{x}}{\partial α} & \frac{\partial {T}_{x}}{\partial β} & \frac{\partial {T}_{x}}{\partial γ} \\ \frac{\partial {T}_{y}}{\partial α} & \frac{\partial {T}_{y}}{\partial β} & \frac{\partial {T}_{y}}{\partial γ} \\ \frac{\partial {T}_{z}}{\partial α} & \frac{\partial {T}_{z}}{\partial β} & \frac{\partial {T}_{z}}{\partial γ}\end{matrix} ) .$$

This shows that the shading of non-Cartesian data sets can be carried out conventionally, but only after the transformation into the projection space.

The observations are therefore restricted in the following to a modification of a base

$${e}_{G} := ( \begin{matrix}\frac{\partial T}{\partial α} , & \frac{\partial T}{\partial β} , & \frac{\partial T}{\partial γ}\end{matrix} )$$

of the projection space. N has the shape of the unit matrix at e_{G}. The associated base

$${e}_{N} := ( \begin{matrix}\frac{\partial T}{\frac{\partial α}{‖ \frac{\partial T}{\partial α} ‖}} , & \frac{\partial T}{\frac{\partial β}{‖ \frac{\partial T}{\partial β} ‖}} , & \frac{\partial T}{\frac{\partial γ}{‖ \frac{\partial T}{\partial γ} ‖}}\end{matrix} )$$

is orthonormal when the original volume G₀ is locally orthogonal—which is the case with cylindrical and spherical coordinate systems—and can therefore be produced by rotation of the standard base of the projection volume Gₚ. N in e_{N} is a diagonal matrix with the elements {q_{α}, q_{β}, q_{γ}} where

$${q}_{α} := ‖ \frac{\partial T}{\partial α} ‖ , {q}_{β} := ‖ \frac{\partial T}{\partial β} ‖ , {q}_{γ} := ‖ \frac{\partial T}{\partial γ} ‖ .$$

This proves that, for locally orthogonal systems, the gradient at G₀ corresponds to a Cartesian gradient, which was transformed by N⁻¹. And N⁻¹ is the diagonal matrix with the reciprocals of these q's. The gradient in G₀ ca therefore be used directly after it has been scaled component-wise with the reciprocals of the q's. A possible implementation of the shading at G₀ is thus already shown.

However, even further properties of the shading should be exploited such that a more efficient implementation can be recited which also applies to non-orthogonal systems which have “drifting” base vectors. Such systems can be generated, for example, by so-called array scanners. Since the gradients themselves are never used in the prior art, but all illumination values are generated from the scalar products (\vec{g},\vec{I}),(\vec{g},\vec{v}) and (\vec{v},\vec{I}) and from an optional scaling with ||\vec{g}||, possibilities for savings result here.

For this purpose, the equations only have to be brought into a suitable form in the original volume. The simple demand is then (\vec{g},\vec{I})=(\vec{g}₀₁,\vec{I}₀ ) (eq. 3) etc., that is the invariance of the scalar products. This demand can be trivially satisfied in that the same Euclidean scalar product is used which is independent of the base. This is, however, not a feasible path, because such a scalar product is complex in calculation. The criterion for the solution approach is simple: g should not be transformed, because a g arises for each pixel, but g and v are only evaluated in each vertex. (\vec{g}ᵢ\vec{I})ₚ=(\vec{g}₀₁,S(\vec{I}₀))ₒ (eq. 4) must therefore be made available with a standard scalar product for the original volume and the projection space which is independent of the base.

In the further procedure, \vec{I}₀^{′} :=S(\vec{I}₀) is explicitly derived.

In the observed point x in the original volume G₀, let the coordinates of the vectors be represented by the base e:={\vec{e}_{α},\vec{e}_{β},\vec{e}_{γ}}, i.e. \vec{g}:=g_{α}\vec{e}_{α}+g_{β}\vec{e}_{β}+g_{γ}\vec{e}_{γ} and \vec{I} :=I_{α}\vec{e}_{α}+I_{β}\vec{e}_{β}+I_{γ}\vec{e}_{γ}. If one observes the scalar products of the base cᵢⱼ :=(\vec{e}ᵢ|\vec{e}ⱼ), then cᵢᵢ=1, but i.a. cᵢⱼ≢0 for the non-orthogonal bases. When written out, the scalar products read:

(\vec{g}, \vec{I})=g_{α}I_{α}+g_{β}I_{β}+g_{γ}I_{γ}+g_{α}I_{β}c_{αβ}+g_{α}I_{γ}c_{αγ}+g_{β}I_{α}c_{αβ}+g_{β}I_{γ}c_{βλ}+g_{γ}I_{α}c_{αγ}+g_{γ}I_{β}c_{βγ}

(eq. 5), with only the first three terms existing with an orthonormal base e.

If the expression in (eq. 5) is grouped by the components of g:

(\vec{g},\vec{I})=g_{α}I_{α}+g_{β}I_{β}+g_{γ}I_{γ}+g_{α}I_{β}c_{αβ}+g_{α}I_{γ}c_{αγ}+g_{β}I_{α}c_{αβ}+g_{β}I_{γ}c_{βλ}+g_{γ}I_{α}c_{αγ}+g_{γ}I_{β}c_{βγ}

(eq. 6) is recognized as a standard scalar product with a new vector I′ with the components

S(I)=(Iₐ+I_{β}c_{αβ}+I_{γ}c_{αγ},I_{β}+I_{α}c_{αβ}+I_{γ}c_{βγ},I_{γ}+I_{α}c_{αγ}+I_{β}c_{βλ}) (eq. 7).

A universal transformation rule for the vectors I and v is thus available with S(I). No real geometrical significance may be ascribed to these new I′ and v′, except that they keep the scalar products invariant in the original volume G₀.

A very simple rule of minimum calculation effort is thus available which allows the calculation of the scalar products in the original volume G₀ in the same manner as in the Cartesian projection space, without T having to be evaluated for this purpose. The “c”s are in turn scalar products of the locals bases, will, however, be global constants for most systems—also for non-orthogonal systems—and therefore not consume any calculation effort.

I and v are linearly interpolated at \vec{x}₀ and \vec{x}₁ and therebetween by the graphics processor; the “g”'s, in contrast, are calculated at each pixel and not only at the vertices. The error introduced by the linearization likewise exists in the Cartesian rendering, since the visual vector sweeps over the visual field, but the sweeping is assumed as a linear operation.

Nevertheless, due to the general projection T, the error of the interpolation is much more complex than in the Cartesian case: the illumination vector I and the observer vector v are both directional vectors which are generated by norming at a point x:

$$v := \frac{x - {x}_{v}}{‖ x - {x}_{v} ‖} \qquad ( eq . 8 )$$

where xᵥ is the observer position. We use (eq. 7) to obtain the simplest possible form of the directional vectors.

The same conditions therefore prevail at G₀ as in Cartesian systems. Since (eq. 3) is linear at G₀, the non-linearity comes solely from the denominator of (eq. 8). The error of the linearisation by the reciprocal function can be estimated for a “sufficiently fine” tessellation in the sense that the denominator of (eq. 8) develops monotonically:

$$e ( t ) := Q \vert [ t \cdot \frac{1}{{d}_{0}} + ( 1 - t ) \cdot \frac{1}{{d}_{1}} ] - [ \frac{1}{t \cdot {d}_{0} + ( 1 - t ) \cdot {d}_{1}} ] \vert . \qquad ( eq . 9 )$$

t ε[0 . . . 1] is the interpolation parameter and the “d”s stand for the denominators in the vertices; and Q is a scaling which comes from the fact that the vectors transformed by (eq. 7) are no longer unit vectors. By the limitations of the “c”s in a3, Q ε]0 . . . 4[ applies. Since e(t)=0,t ε{0,1}, the error maximum can be evaluated at the extremes of e:

$$\frac{e ( t )}{dt} = 0 \to \frac{1}{{d}_{0}} - \frac{1}{{d}_{1}} + \frac{{d}_{0} - {d}_{1}}{{( t \cdot {d}_{o} + ( 1 - t ) \cdot {d}_{1} )}^{2}} = 0 , \qquad ( eq . 10 a )$$

which are evaluated, for the non-trivial case date d₀≢d₁ (otherwise the error is identical to 0), to:

$${( t ( {d}_{0} - {d}_{1} ) + {d}_{1} )}^{2} = - \frac{{d}_{0} - {d}_{1}}{\frac{1}{{d}_{0}} - \frac{1}{{d}_{1}}} = \frac{{d}_{1} - {d}_{0}}{{d}_{1} - {d}_{0}} {d}_{0} {d}_{1} = {d}_{0} {d}_{1}$$

and thus

$$t = \frac{\pm \sqrt{{d}_{0} {d}_{1}} - {d}_{1}}{{d}_{0} - {d}_{1}} . \qquad ( eq . 10 b )$$

The solution is clear, since t ε[0 . . . 1] and there must therefore be a plus sign before the root.

This results in a handy criterion to determine the fineness of the tessellation.

By reinstating (eq. 10b) in (eq. 10a), one obtains:

$$\begin{matrix}e ( t ) := Q \vert ( \frac{\sqrt{{d}_{0} {d}_{1}} - {d}_{1}}{{d}_{0} - {d}_{1}} ) \cdot ( \frac{1}{{d}_{0}} - \frac{1}{{d}_{1}} ) + \frac{1}{{d}_{1}} - \\ \frac{1}{\frac{\sqrt{{d}_{0} {d}_{1}} - {d}_{1}}{{d}_{0} - {d}_{1}} \cdot ( {d}_{0} - {d}_{1} ) + {d}_{1}} \vert \\ = Q \vert ( \frac{\sqrt{{d}_{0} {d}_{1}} - {d}_{1}}{{d}_{0} {d}_{1}} ) + \frac{1}{{d}_{1}} - \frac{1}{\sqrt{{d}_{0} {d}_{1}}} \vert \\ = Q \vert \frac{1}{{d}_{1}} - \frac{1}{{d}_{0}} \vert .\end{matrix} \qquad ( eq . 11 )$$

This gives the surprising result that, in a similar manner as for (eq. 1), errors<1 can be forced. If do is predetermined, then (eq. 11) specifies in which range d₁ can be selected.

It is even the case that one can treat the tessellation comparatively carelessly as long as one remains in the original volume G₀, because one then does not approach any singularity and the “d”s remain comparatively large. The method is restricted by the geometric error of (eq. 1) and not by the errors of the shading approximation (eq. 9) for “d”s larger than 1.

Previously the following was shown: the scalings and transformations necessary for the general shading and rendering can be carried out with elementary calculation operations. The correct illumination values are obtained in the vertices, the interpolated values contain at most errors of the second order as described in (eq. 9). The evaluation in the vertices is also elementary and the vertices are not very compact (and also do not have to be very compact) from the point of view of the calculation effort; their evaluation is consequently not the bottleneck of the calculation.

The invention will now be described in more detail in the following with reference to the schematic drawing. There are shown:

FIG. 1 a method known from the prior art for visualising an original volume;

FIG. 2 generation of a planar texture in accordance with the prior art;

FIG. 3 linearising of a spherical shell-like texture;

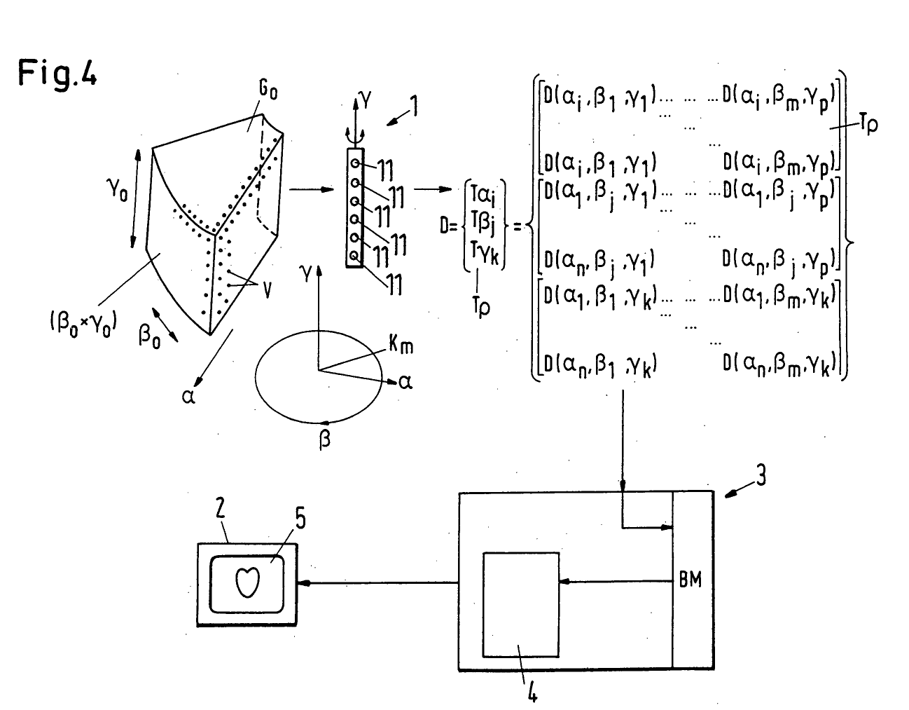

FIG. 4 an embodiment of the method in accordance with the invention;

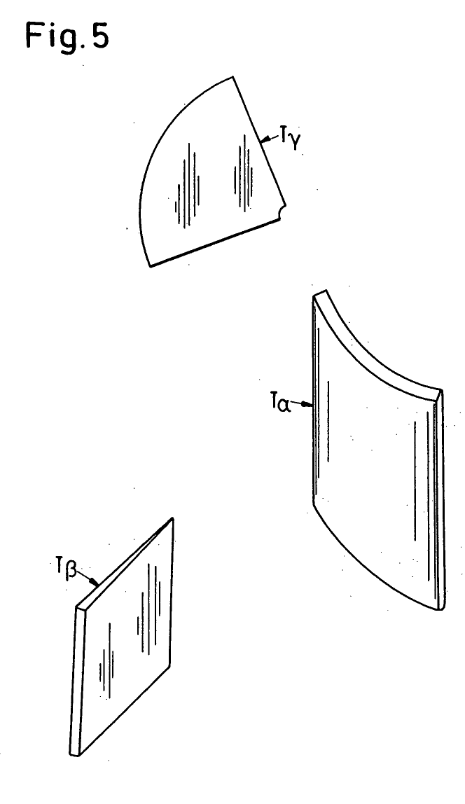

FIG. 5 examples for textures in cylinder coordinates;

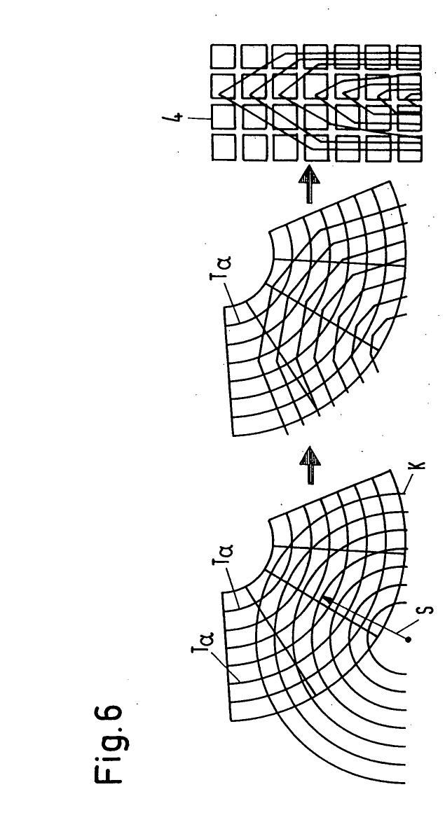

FIG. 6 an embodiment for a linearisation in curvilinear coordinates.

FIGS. 1 to 3 show the prior art and were already discussed in detail in the above.

FIG. 4 shows schematically the most important steps of an embodiment of the method in accordance with the invention. The important case for practice should be referred to as an example with reference to FIG. 4 that a data set D is based on measured values D(α, β, γ) which result from a volume-resolved scan of a body; and that a three-dimensional representation is generated from this data set D. It is meant by “three-dimensional representation” that the representation actually is three-dimensional, or that, for example, a stereoscopic projection is generated by a suitable projection apparatus, or that the projection takes place in a planar manner, for example on a computer monitor, but a three-dimensional impression is provided, e.g. by means of methods of spatial or perspective representation, in particular using a corresponding illumination model. Such representations can specifically be semi-transparent such that they allow an insight into the scanned body.

In the embodiment shown in FIG. 4, an original volume G₀, for example the heart G₀ of a human body, is scanned with a measuring device 1, in the present example with an ultrasonic measuring device 1. Such an ultrasonic measuring device 1 includes, for example, a plurality of ultrasonic converters 11 of which a plurality are arranged adjacent to one another with respect to an axis γ. During operation, the ultrasonic measuring device 1 is rotated about the axis γ, as is indicated by the double arrow at the axis γ of the ultrasonic measuring apparatus 1 in FIG. 4. The individual ultrasonic converters 11 are operated substantially in parallel such that the original volume G₀, that is for example a heart, is scanned with ultrasound simultaneously in a plurality of parallel layers, which each lie substantially perpendicular to the γ axis, over a sector (β₀ X γ₀). The infor- mation with respect to the third dimension in the direction α is gained, for example, from the run time of the ultrasonic echo.

The volume-resolved data D(α, β, γ) is thus present, optionally after a technical signal pre-processing, as a spatially resolved data set D which contains the information of the structure to be imaged. The dataset D is set up by so-called textures Tρ which represent slices through the original volume G₀. The measurement coordinate system Kₘ, in which the data D(α, β, γ) are present, is predetermined by the ultrasonic measuring device 1 itself or by its manner of operation. The example described here is one of cylindrical coordinates. The textures Tρ then correspond, as shown in FIG. 5, to three different surface types, that is texture types Tα, Tβ and Tγ at which one each of the cylinder coordinates α, β, γ has a constant value. The use of the method in accordance with the invention is naturally by no means restricted to cylindrical coordinates, but can also be used on other curvilinear coordinates and naturally also on Cartesian coordinates and what has been said above applies completely analogously for other coordinates than cylindrical coordinates. The data set D generated by the ultrasonic measuring device 1 is loaded into a data processing unit 3 and is processed there. Optionally after a mathematical preparation phase, the illumination model, i.e. the illumination functions underlying this is evaluated first in the measurement coordination system Kₘ, i.e. the “inner shading” described above is carried out.

The data are then subjected to the “rendering” likewise described above and supplied to the graphics hardware 4 with whose aid a three-dimensional representation of the image 5 to be projected takes place, for example on an observation monitor 2.

FIG. 5 shows schematically the three texture types for the case that the measurement coordinate system Kₘ has cylindrical symmetry. If the measurement coordinate system Kₘ has a different symmetry, for example spherical symmetry, the textures Tα, Tβ, Tγ or the surfaces representing them naturally have a different geometry corresponding to the symmetry of the coordinate system.

In accordance with the invention, after the carrying out of the shading, i.e. after the evaluation of the illumination model BM in the measurement coordinate system Kₘ, the data set D, or the textures Tρ, are linearised in the measurement coordinate system Kₘ, i.e. are subjected to the process of rendering. This should be briefly explained by way of example in FIG. 6 in a schematic representation for a group of Tα textures of a data set in a cylindrically symmetrical measurement coordinate system Kₘ.

As already explained in detail, the visual vector S (or the illumination vector) will not have a constant amount either on planar textures Tρ or on curvilinearly bounded textures Tρ; it is rather the case that the amount of these vectors is constant on spherical shells K, as shown schematically in the left hand drawing of FIG. 6. The visual vector S thus generally changes over a slice, i.e. over a texture Tρ.

Because changes in amount of the visual vector S as a rule thus do not depend linearly on the texture coordinates of the textures Tρ, these also cannot be directly encoded on the graphic hardware 4. The curvilinearly bounded textures Tρ are therefore linearised, as shown in the middle drawing of FIG. 6, such that curvilinearly bounded part surfaces are created. The corner points of these part surfaces can now be encoded on the graphics hardware 4, as shown schematically in the right hand drawing of FIG. 6, and can be shown, for example, on an observation monitor 2 as FIG. 5, without carrying out a coordinate transformation.

It is thus possible by the method in accordance with the invention to directly encode in a particularly elegant and efficient manner multi-dimensional data sets which are present in any desired curvilinear coordinates, e.g. in cylindrical symmetry or in spherical symmetry, without any great calculating effort and enormously fast on customary graphics hardware while taking a corresponding illumination model into account. This is achieved in that the process of the so-called shading, that is of the evaluation of the illumination functions, and of the rendering, i.e. the process of the linearisation operations, are completely separated: the illumination functions are evaluated in the original volume, that is in the measurement coordinate system, and only then linearised. Since the evaluation of the data sets is possible with elementary calculation operations and the shading takes place exclusively in the original volume and not only in the projection space, as known from the prior art, the method in accordance with the invention is enormously fast so that the visualisation even of very complex data sets is possible in real time. Even the visualisation of moving processes in a stereoscopic representation becomes possible with high resolution and refresh rates which correspond to typical video frequencies. Since the illumination functions are evaluated in the original volume and not in the projection space, it is possible with the method in accordance with the invention—thanks to its considerable speed in the carrying out of the visualisation operations—also to use very complex illumination models such that high resolution and realistic representations of previously unachieved quality can be achieved.

1. A method for visualising a spatially resolved data set (D) using an illumination model (BM), with a datum (D(α, β, γ)) of the data set (D) being associated in each case with a volume element (V) whose position is described by coordinates (α, β, γ) in a measurement coordinate system (Kₘ), with the data (D(α, β, γ)) being loaded as at least one texture (Tαᵢ, Tβⱼ, Tγₖ) into graphics hardware in order to generate a pictorial representation (5) in a projection space, characterised in that the illumination model (BM) is evaluated in the measurement coordinate system (K_{M}).

2. A method in accordance with claim 1, in which the data (D(αa, β, γ)) of the data set (D) are processed without transformation from the measurement coordinate system (K_{M}) into another coordinate system, in particular without transformation into a Cartesian and/or isotropic coordinate system.

3. A method in accordance with claim 1, in which the measurement coordinate system (K_{M}) is a non-Cartesian measurement coordinate system (K_{M}).

4. A method in accordance with claim 1, in which the measurement coordinate system (K_{M}) is a cylindrical system or a spherical coordinate system (K_{M}).

5. A method in accordance with claim 1, in which linear interpolation is carried out between the data (D(α, β, γ)) of the data set (D) in the measurement coordinate system (K_{M}).

6. A method in accordance with claim 1, in which the illumination model in the data set (D) is evaluated close to a singularity.

7. A method in accordance with claim 1, in which the data (D(α, β, γ)) of the data set (D) represent a volume resolved scan of a body (G₀); and in which the pictorial representation (5) is a three-dimensional representation (5), in particular a semi-transparent representation (5), of the body (G₀).

8. A method in accordance with claim 1, in which the pictorial representation (5) is generated as a stereoscopic projection.

9. A method in accordance with claim 1, in which the data (D(α, β, γ)) of the data set (D) are generated by means of an ultrasonic measuring device (1).

10. Use of a method in accordance with claim 1, in particular for medical purposes, for the fast generation of three-dimensional representations (5) of a body (G₀), in particular of a human body or parts thereof, with reference to data (D(α, β, γ)) gained by a technical measurement.
